(19) United States
(12) Patent Application Publication
(10) Pub. No.: US 2004/0037671 A1
(43) Pub. Date: Feb. 26, 2004

(54) Semi-automatic tube clip fastener applicator machine

(76) Inventors: Frank Vercillo, West Babylon, NY (US); James Saladino, Dix Hills, NY (US)

Correspondence Address: ALFRED M. WALKER, 225 OLD COUNTRY ROAD, MELVILLE, NY, 11747-2712, US

(21) Appl. No.: 10/226,650

(22) Filed: Aug. 22, 2002

(51) Int. Cl. B42C 1/00

(52) U.S. Cl. 412/9

(57) ABSTRACT

A semi-automatic tube clip fastener application machine transfers document holding tube clips sequentially and discretely to backing sheets of folders, such as medical records folders, business folders and the like. A continuous release liner is arranged in a continuous carrier, such as a wound roll or a stacked array of connected discrete fan fold sheets. A user operable starter, such as a foot pedal or hand operable starter commences movement of an advancing means which advances tube clips. A lifter, such as a vacuum block, sequentially and discretely lifts each tube clip reaching the roller from the release liner and transfers each tube clip to a backing sheet of the folder. The vacuum block transports the lifted tube clip to a point above the backing sheet which is located on a platform, and the tube clip is pushed against the backing sheet for attaching the lifted tube clip to the backing sheet, whereupon the vacuum block releases the tube clip upon temporary cessation of the vacuum.

### FIELD OF THE INVENTION

The present invention relates to a semi-automatic apparatus and method for transferring folder page binding tube clips sequentially to backing sheets of data containing folders.

### BACKGROUND OF THE INVENTION

One type of fastener used to bind together perforated sheets of paper in a folder (or to a heavy backing sheet) is what is known in the trade as the Tube Clip. This fastener is used to facilitate rapid updating of bound documents where old sheets are often discarded and new updates are added as replacements.

Tube Clips are usually supplied as individual clips with an adhesive backing on the mounting pad protected by a release liner. Typically, the user assembles his or her own folder by first removing the release liner and then carefully attaching the Tube Clip in the desired location. Only then is the assembly ready for accepting sheets to be bound.

To assemble a number of folders manually is a tedious job because proper alignment of the Tube Clip to the folder and then applying appropriate pressure for good adhesion must be done carefully.

### OBJECTS OF THE INVENTION

It is therefore an object of the present invention to provide a machine for rapidly and automatically fastening Tube Clip fasteners to folder sheets of a loosely bound folder.

It is also an object of the present invention to provide a machine which removes a Tube Clip fastener from its adhesive backing and properly aligns the Tube Clip fastener into position within a folder sheet.

It is yet another object of the present invention to provide a Tube Clip fastener applicator machine which applies an accurate source of pressure for proper adhesion of the Tube Clip fastener to a folder sheet.

### SUMMARY OF THE INVENTION

In keeping with these objects and others which may become apparent, the present invention includes a machine used to automatically adhere a tube clip fastener to a sheet of paper or file folder in various desired positions.

The machine is pneumatically operated with a programmable logic controller (PLC) used to control machine functions.

The tube clips are mounted on a roll, fed through the machine, picked off the roll, and attached. A foot pedal to start the application process operates the machine. Sheets or folders are fed by hand or otherwise to complete the application procedure.

The semi-automatic tube clip fastener application machine transfers document holding tube clips sequentially to backing sheets of folders, such as medical records folders, business folders and the like. A continuous release liner is arranged in a continuous carrier, such as a wound roll or a stacked array of connected discrete fan fold sheets.

A user operable starter, such as a foot pedal or hand operable starter commences movement of an advancing means which advances tube clips.

The tube clips are mounted on one side of the release liner and are positioned spaced and parallel to each other on the release liner. The release liner in the form of the continuous carrier is advanced by a direction reversal roller which is in contact with a side of the release liner opposite to the side containing the tube clips. A lifter, such as a vacuum block, sequentially and discretely lifts each tube clip reaching the roller from the release liner and transfers each tube clip to a backing sheet of the folder. The vacuum block transports the lifted tube clip to a point above the backing sheet which is located on a platform, and the tube clip is pushed against the backing sheet for attaching the lifted tube clip to the backing sheet, whereupon the vacuum block releases the tube clip upon temporary cessation of the vacuum.

To advance the tube clips there is also a driven roller in contact with an idler roller for pulling the release liner in the form of the continuous carrier around the direction reversal roller a distance equal to the spacing of each tube clip on the release liner between each removal of a tube clip from the release liner so that the next tube clip is in a position to be engaged by the vacuum block.

In operation, tube clips are sequentially mounted on the continuous release liner into a continuous carrier, such as a wound roll or stacked array of connected, discrete fan fold sheets, which has the tube clips mounted on one side of the release liner. The tube clips are positioned spaced and parallel to each other on said release liner.

The release liner is advanced around a direction reversal roller which is in contact with a side of said release liner opposite to the side containing the tube clips. A lifter such as a vacuum block lifts each tube clip reaching the direction reversal roller from the release liner and transfers the lifted tube clip to the folder backing sheet. The vacuum block transports the lifted tube clip to a point above the backing sheet located on a platform, pushes the lifted tube clip against the backing sheet, to attach the lifted tube clip to the backing sheet and releases the tube clip.

A additional driven roller is in contact with an idler roller. This driven roller pulls the release liner from the continuous carrier release liner around the direction reversal roller a distance equal to the spacing of each tube clip on the release liner between each removal of a tube clip from the release liner, so that the next tube clip is in a position to be engaged by the vacuum block.

In one embodiment, the tube clips are mounted upon the release liner spaced adjacent to each other without a gap therebetween. To avoid having two tube clips being moved simultaneously by the vacuum block, a temporary holding block trailing the vacuum block temporarily holds each subsequent tube clip of said tube clips while a preceding advanced tube clip is being pulled from said release liner by said vacuum block.

In a second embodiment, the holding block is not necessary, because a gap is provided between each spaced and parallel positioned tube clip, so that an advanced tube clip of the tube clips is being pulled from the release liner by the vacuum block without pulling the next tube clip separated by the preceding advanced tube clip.

The vacuum block is lowered to the tube clip adjacent to the direction reversal roller. Vacuum is applied to the vacuum block to engage said tube clip. The vacuum block lifts the tube clip from the release liner. The vacuum block is moved while holding the tube clip to an attachable position above the stack of backing sheets. Then the vacuum block is lowered and presses the tube clip against one backing sheet on the stack of backing sheets until the tube clip adheres to the backing sheet. Thereafter the vacuum is shut off, which then releases the tube clip adhered to the backing sheet.

Thereafter, the continuous carrier of the release liner in the form of a wound roll or a stacked array of connected, discrete fan fold sheets, is advanced until the next tube clip is adjacent the direction reversal roller. The vacuum block is then returned to its position above the next tube clip and the cycle is repeated.

### BRIEF DESCRIPTION OF THE DRAWINGS

The present invention can best be understood in conjunction with the accompanying drawings, in which:

FIG. 1 is a sequence of six perspective views showing the various steps in using a tube clip fastener;

FIG. 2 is a front perspective view of the tube clip application machine of this invention;

FIG. 2A is a side schematic view of the basic elements of the application machine thereof;

FIG. 2B is a detailed top plan view of the application machine thereof;

FIG. 3 is a detail showing spaced-out tube clips attached to a feeder substrate;

FIG. 4 is a perspective detail of a rotary actuator pulling tube clip substrate within rollers;

FIG. 5 is a top perspective detail showing a tube clip being picked off substrate by vacuum block;

FIG. 6 is a perspective view similar to FIG. 5 illustrating the step of attaching tube clip to folder;

FIG. 7 is a perspective view similar to FIG. 6 showing the step of returning vacuum block laterally to pick up next tube clip;

FIG. 8 is a front perspective view of an alternate embodiment tube clip application machine which can handle tube clips on a substrate with no gap between;

FIG. 9 is a detail top view showing tube clips on substrate with no gap between;

FIG. 10 is a side schematic view of the first step in a sequence showing the use of a temporary holding block;

FIG. 11 is side view of step 2 showing the start of holding block deployment after vacuum block engages tube clip;

FIG. 12 is a side view of step 3 wherein vacuum block with tube clip is retracted and holding block holds next sequential tube clip;

FIG. 13 is a side view of step 4 where vacuum block with tube clip is transported laterally;

FIG. 14 is a side view of step 5 wherein vacuum block has extended downward to attach tube clip to folder;

FIG. 15 is a side view of the last step of the sequence whereby vacuum block without tube clip is returned laterally toward the starting position while holding block is starting to deploy vertically;

FIG. 16 is a Flow chart of overall process for attaching a tube clip using the application machine of the present invention; and,

FIG. 17 is a Flow chart of a programmable logic control (PLC) sequence for control of the application machine of the present invention.

### DETAILED DESCRIPTION OF THE INVENTION

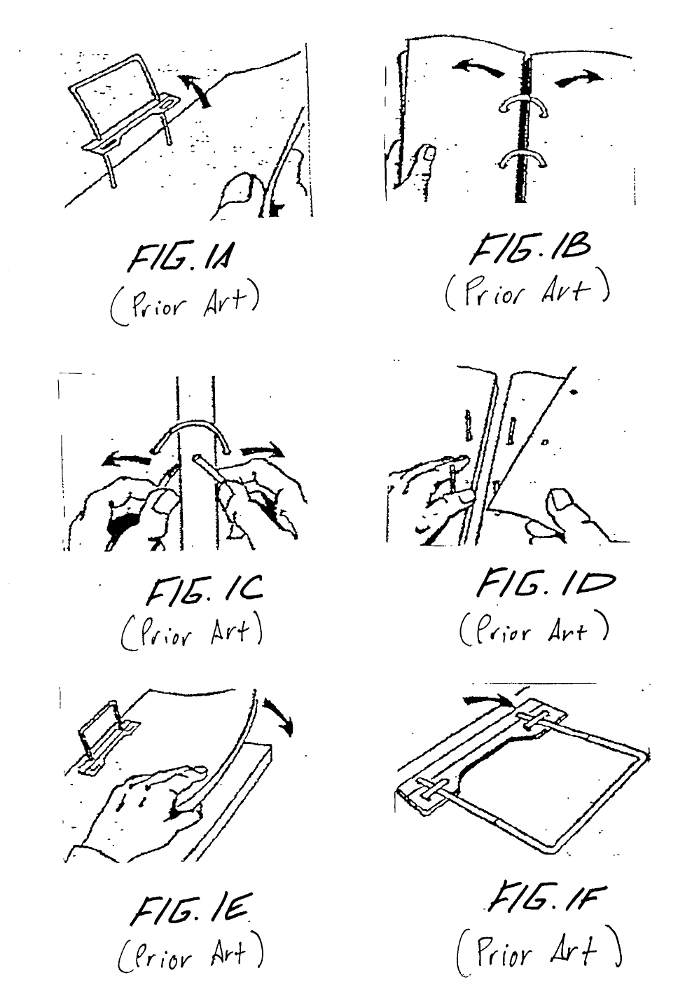

FIG. 1 is a prior art diagram showing the sequence of the various steps in using a tube clip fastener For example, the prior art tube clip itself and the sequence of performing an update of a document set is illustrated in the six pictorial steps shown in FIG. 1. This sequence applies both to manually applied tube clips of the prior art as well as to the machine applied tube clips of the present invention.

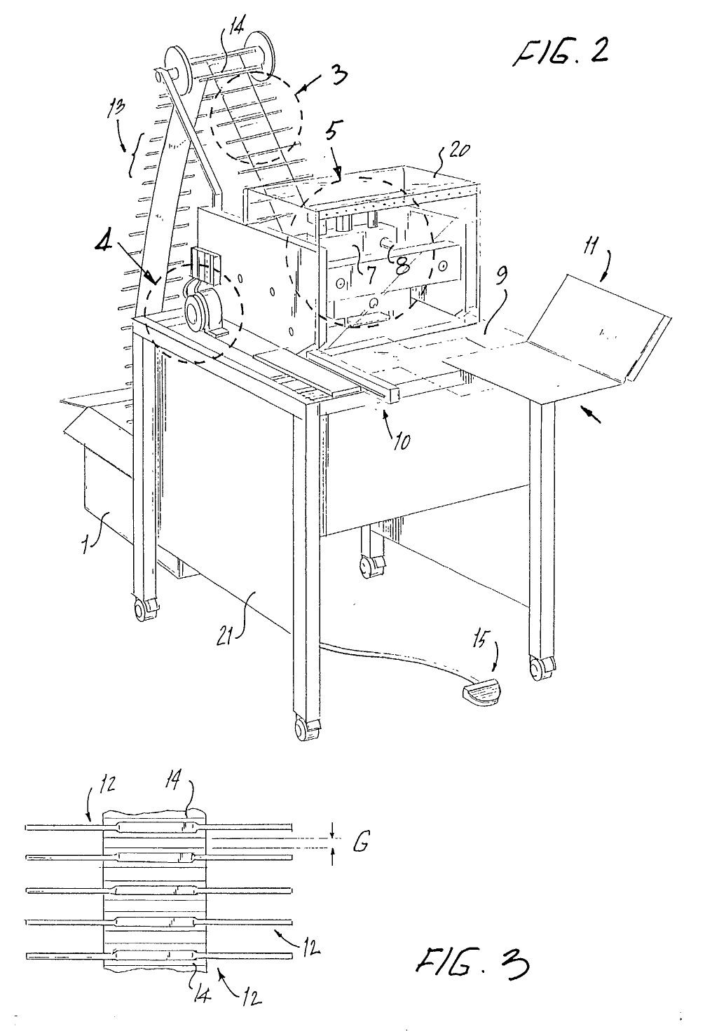

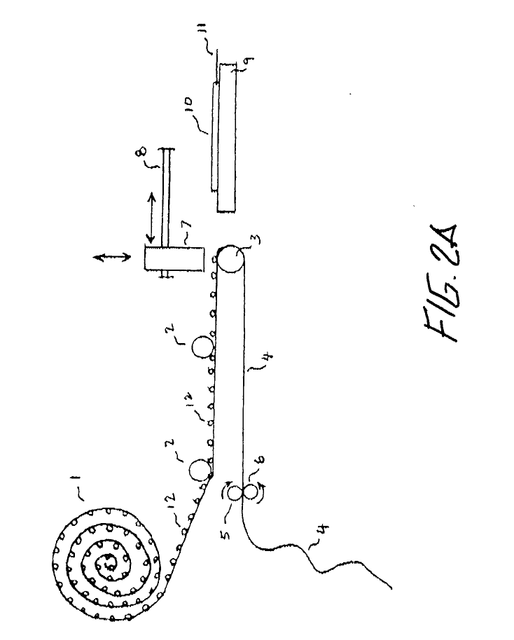

FIGS. 2, 2A and 2B illustrate the salient features of the attachment machine of the present invention. One important innovation is to supply the tube clips 12 in fan fold or roll form 1 by using a continuous sheet 4 with upper release liner 14 to attach them together. A fan fold of supply sheet 4 with sheets 13 is illustrated. Rollers 2 are used to guide the tube clips 12 into a planar sequence under vacuum block (VB) 7 which can be raised and lowered and also moved laterally as guided by rails 8.

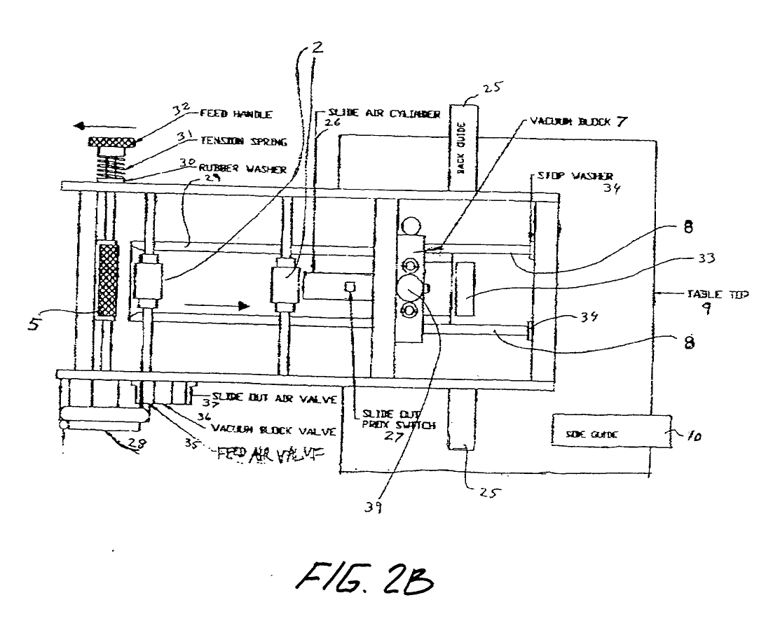

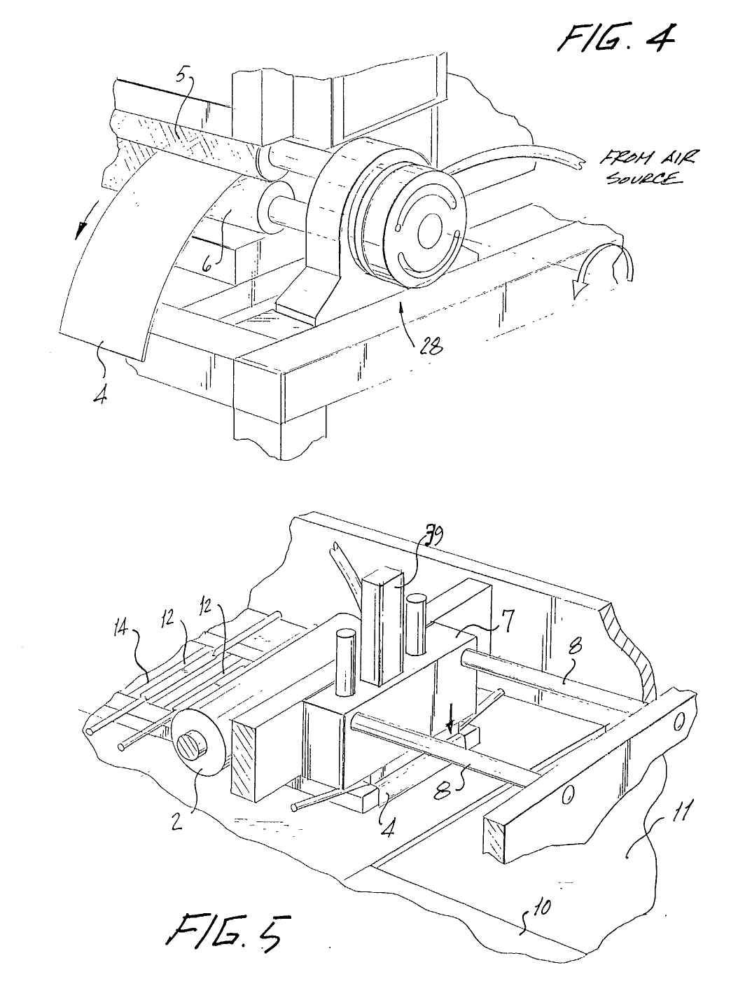

FIG. 3 shows a gap “G” between adjacent tube clips 12 located upon supply sheet 14. FIGS. 4-7 show the components where gap “G” is provided between adjacent tube clips 12.

FIGS. 2A and 4 also show that the release liner 4 is guided over direction reversal roller 3 and is engaged by driven knurled roller 5 and knurled idler roller 6. Knurled roller 5 is guided by rotary activator 28.

Table top 9 holds folder or backing sheet 11 within side guide 10.

As further shown in FIGS. 2A, 5, 6 and 7 the overall machine sequence, vacuum block (VB) 7 is lowered and vacuum is applied to grasp the tube clip 12 under it; when roller 5 is turned 90 degrees to advance release liner 4 a distance equal to the width of one tube clip base, that tube clip 12 is thereby detached from release liner 4. Vacuum block (VB) 7 is then moved laterally along rails 8, while carrying one tube clip 12 to the desired position on folder or sheet 11. Vacuum block (VB) 7 is then pushed down to attach tube clip 12 to sheet or folder 11 upon table top 9.

FIG. 2 shows a front perspective view of the tube clip attachment machine showing the physical placement of machine base 21, sealing head 20 containing the mechanisms of FIG. 2A, table top 9, side guide 10 and tube clip roll 1. Control foot pedal 15 is also shown.

The top plan view detail of FIG. 2B shows the internal components of sealing head 20. For example, a folder or backing sheet is positioned by two adjustable guides to select the proper attachment position; back guide 25 as well as side guide 10. Knurled roller 5 is driven by rotary actuator 28, such as a pneumatic rotary actuator, through a one-way clutch (not shown).

FIG. 2B also shows that feed handle 32, tension spring 31 and rubber washer 30 are used in adjusting and initially threading release liner 4 through knurled rollers 5 and 6. As further shown in FIG. 2B, horizontal air cylinder 26 moves vacuum block (VB) 7 along rails 8 to stop washers 34. Proximity switch 27 is an interface to the Programmable Logic Control (not shown).

As also shown in FIG. 2B, solenoid valves 35,36, and 37 control air to rotary actuator 28, vacuum to vacuum block (VB) 7, and air to air cylinder 26 respectively. They are actuated by the Programmable Logic Control.

Guide plate 29 guides release liner 4 into rollers 5 and 6 by grooves in its side edges. Vertical movement air cylinder 39 moves vacuum block (VB) 7 up and down as required (under a Programmable Logic Control solenoid valve control—not shown).

Moreover, rubber pad 33 is a support under folder or sheet 11 at the site of impact by vacuum block (VB) 7 during the tube clip final attachment move.

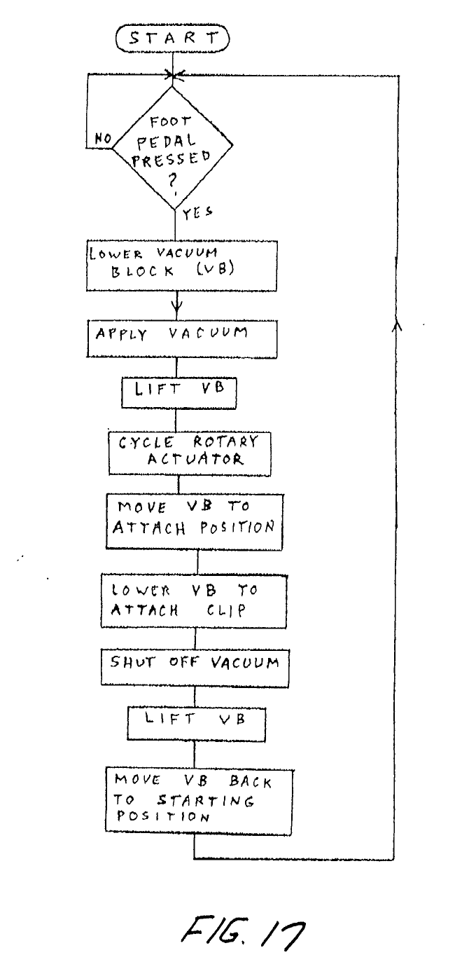

FIG. 16 shows the overall flow chart of operator interaction with the tube clip attachment machine. The operator first loads a roll of tube clips and checks or adjusts the paper/folder guides for proper positioning. At this point, the operator is ready for some quick repetitive tube clip attachment using the machine.

FIG. 16 also shows that after feeding a folder into the guide, the operator presses a foot pedal 15 which starts the automatic Programmable Logic Control (PLC) attachment sequence. After tube clip attachment, the operator removes the completed folder or sheet. More folders or sheets can now be processed by repeating the same sequence of simple operations.

The Programmable Logic Control (PLC) operations are shown in the flow chart of FIG. 17. This is a high level flow with multiple instructions often required for each of the operations shown.

The sequence is started by the operator pressing the foot pedal. Vacuum block VB is depressed to contact a tube clip. After vacuum is applied, vacuum block VB is lifted and the rotary actuator is cycled to separate the release liner from the tube clip grasped by the vacuum block.

This action also positions the next tube clip in sequence under the vacuum block VB “home position”. Vacuum block VB with attached tube clip is then moved laterally to the attach position above the folder or sheet. Vacuum block VB is then lowered, pressing tube clip to folder/sheet surface, thereby bonding the two items to each other. The vacuum is shut off thereby ungrasping the tube clip just bonded, and vacuum block VB is lifted and then moved back to the starting position above the next tube clip in sequence. This sequence is repeated with each pedal push.

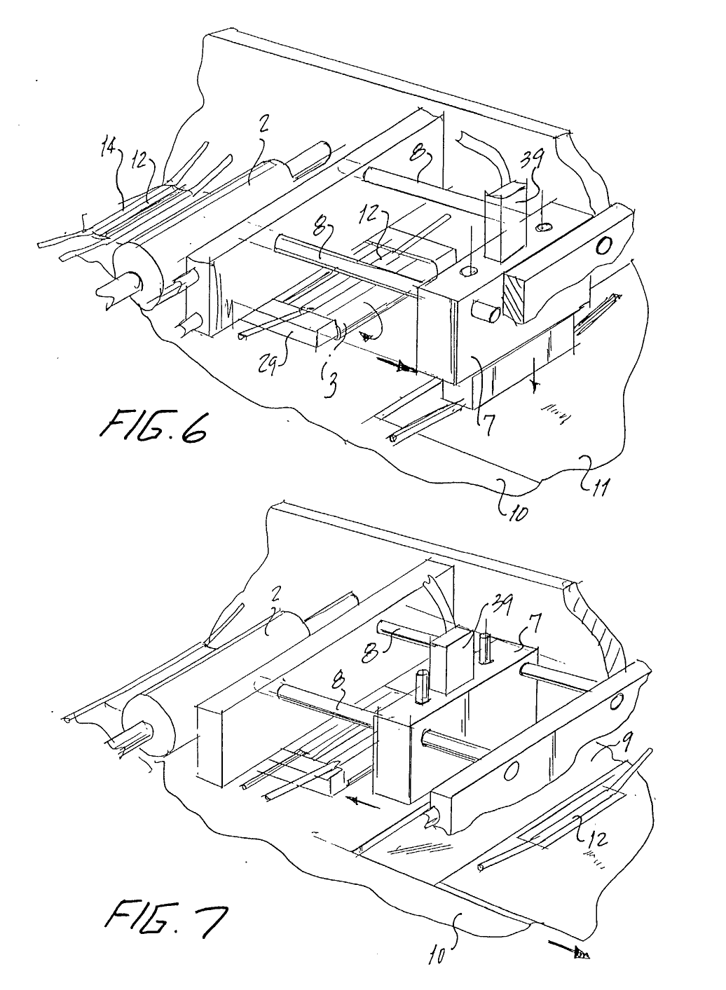

In certain circumstances, where tube clips 12 are provided adjacent to each other with no gap, such as gap “G” therebetween, occasionally vacuum block 7 may accidentally pull two clips up at once, which is not desirable. Therefore, FIGS. 8-15 show an alternate embodiment designed to alleviate this problem.

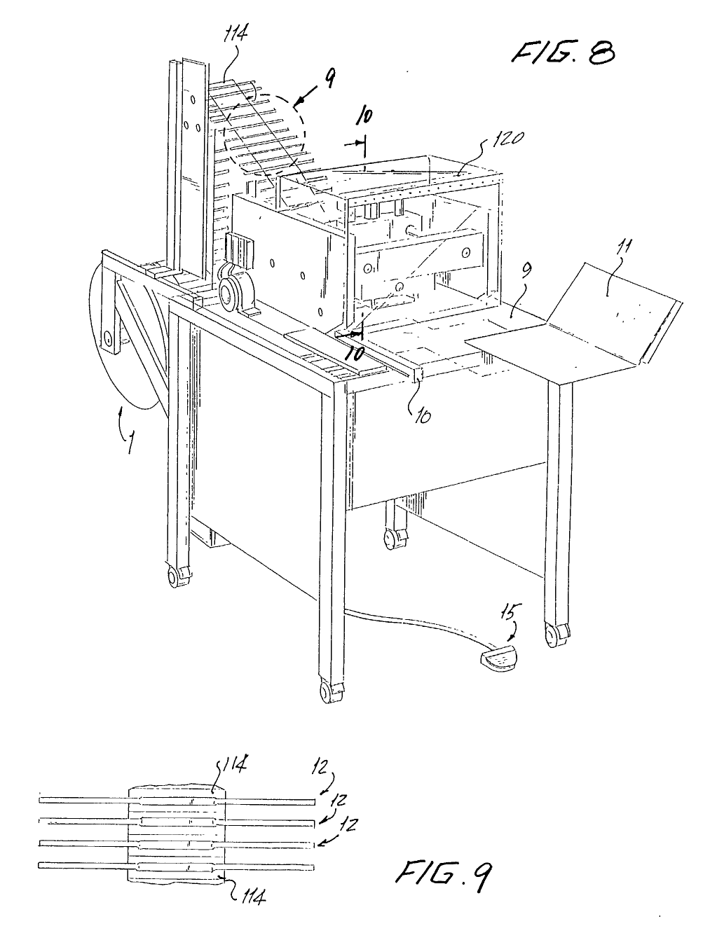

FIG. 8 shows an alternate embodiment attachment machine which is designed to handle tube clips 12 on upper release liner 114 above substrate 104, which tube clips 12 are attached to upper release liner 14 with no gap (such as “G” in FIG. 3), as shown in FIG. 9. Sealing head 120 contains the mechanism including holding block 150. A reel 1 is shown with upper release liner 114 upon continuous substrate 104 as opposed to a fan-fold as illustrated previously; either method can be used.

The sequence of drawings from FIG. 10 through FIG. 15 show the various steps in an automatic sequence controlled by a PLC as initiated by foot pedal 15 which controls the vertical and lateral deployment of vacuum block 7 in conjunction with vertical deployment of holding block 150 to achieve attachment of a tube clip 12 to folder 11 from substrate 114. The detailed sequence can be followed from the drawing description which describes the function of each step of the sequence.

For example, FIG. 10 shows rail 108 supporting vacuum block 7 adjacent to holding block 150 elevated above tube clips 12 upon upper release liner 114 of continuous supply sheet substrate 104.

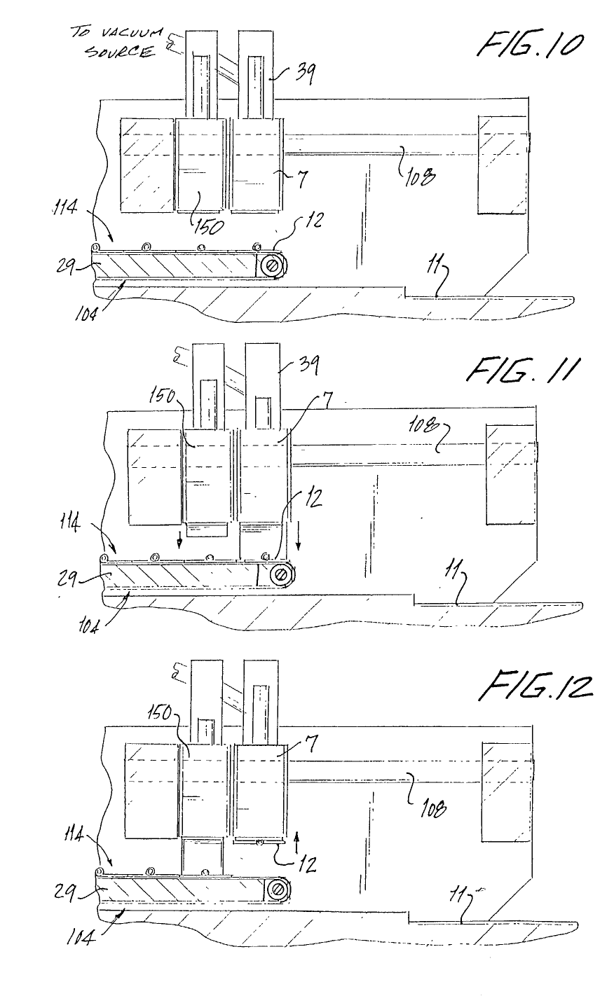

Thereafter, in FIG. 11, vacuum block 7 is advanced downward to leading tube clip 12. As shown in FIG. 12, as vacuum block 7 pulls leading tube 12 upward from upper release liner 114, holding block 150 engages against next trailing tube clip 12, holding it in place while leading tube clip 12 is pulled up from release line 114, thereby preventing next trailing tube clip 12 from being accidentally pulled up prematurely with leading tube clip 12.

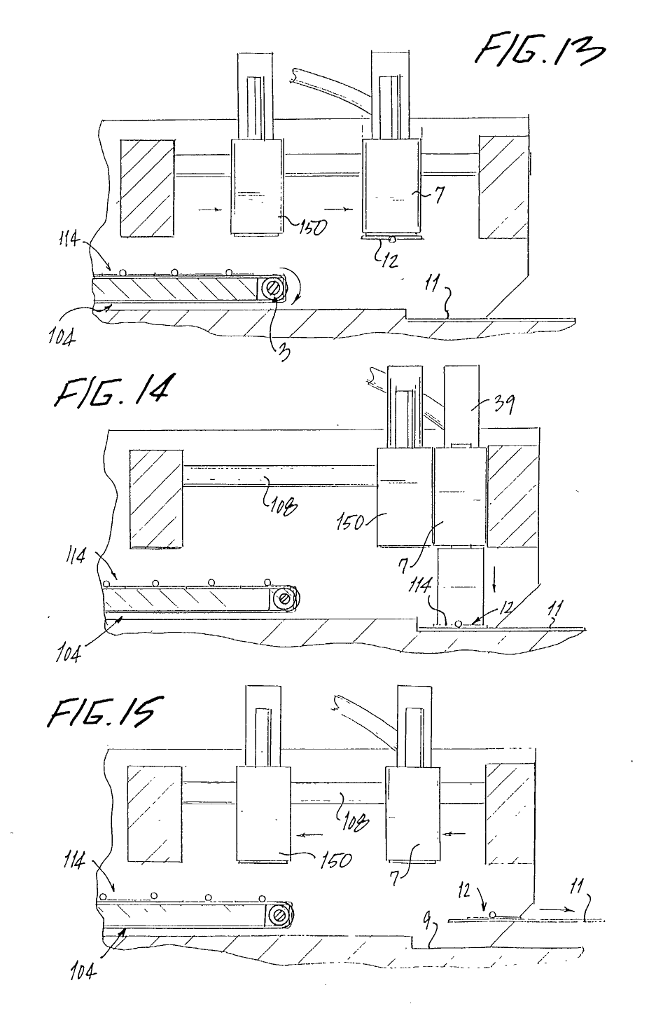

As shown in FIG. 13, holding block 150 is released from holding next trailing tube clip 12, which is advanced to be the next leading tube clip. Meanwhile the original leading tube clip 12 is pulled laterally toward a position above folder 11.

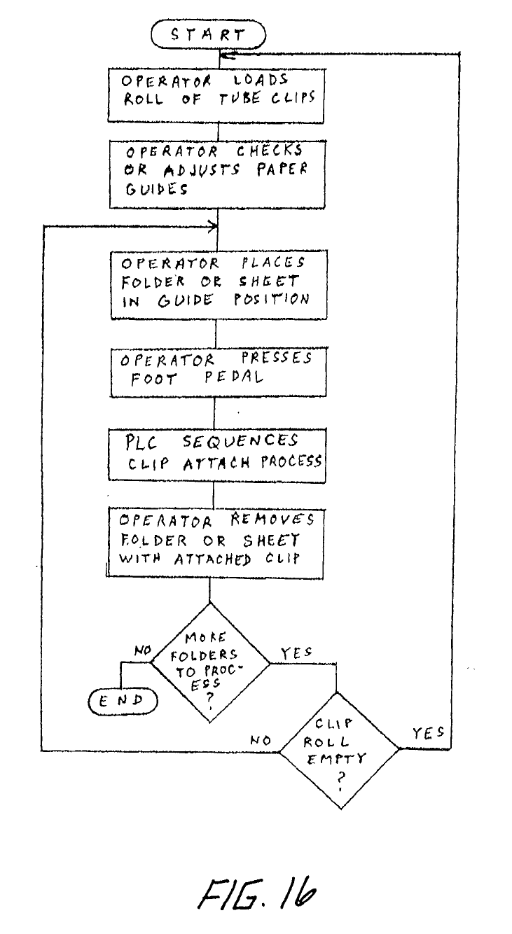

FIG. 14 shows vacuum block 7 advancing tube clip 12 onto folder 11. While FIG. 14 shows holding block moving laterally along rail 108, it is assumed that in alternate embodiments (not shown) holding block may be only vertically movable, and not movable horizontally along rail 108.

FIG. 15 shows holding block 150 and vacuum block 7 retreating rearward for the next lifting sequence of the next leading tube clip 12, as folder 11 with tube clip 12 thereon is moved horizontally away from the table top 9.

Holding block 150 is shown moving laterally. However in alternate embodiments it can move only vertically (not shown).

When vacuum block 7 moves laterally on rails 108, it is preferably moved laterally. The actual attachment of a pneumatic cylinder to effect this movement is not shown.

It is further noted that other modifications may be made to the present invention, without departing from the scope of the invention.

We claim:

1. A semi-automatic apparatus for transferring document holding tube clips sequentially to backing sheets comprising:
a continuous release liner arranged in a continuous carrier having tube clips mounted on one side of said release liner, said tube clips being spaced and parallel to each other on said release liner;
user operable starter commencing movement of an advancing means for advancing said release liner from said continuous carrier including a direction reversal roller, said direction reversal roller being in contact with a side of said release liner opposite to the side containing said tube clips;
lifting means adjacent said direction reversal roller for sequentially and discretely lifting each tube clip reaching said roller from said release liner and transferring said tube clip to a backing sheet.

2. The apparatus of claim 1 in which said lifting means comprises a vacuum block for lifting each tube clip from said release liner, transporting the lifted tube clip to a point above a backing sheet located on a platform, and pushing said lifted tube clip against said backing sheet for attaching the lifted tube clip to said backing sheet, said vacuum block releasing said tube clip upon temporary cessation of the vacuum.

3. The apparatus of claim 1 wherein said continuous carrier of said document holding tube clips is a roll.

4. The apparatus of claim 1 wherein said continuous carrier is a stacked array of discrete fan fold continuously attached sheets.

5. The apparatus of claim 2 in which said advancing means also comprises a driven roller in contact with an idler roller for pulling said release liner from said continuous carrier around said direction reversal roller a distance equal to the spacing of said tube clips on said release liner between each removal of a tube clip from said release liner so that the next tube clip is in a position to be engaged by said vacuum block.

6. The apparatus of claim 1 wherein said user operable starter is a sequentially and discretely operable foot pedal.

7. The method of sequentially mounting tube clips on backing sheets comprising the steps of:
forming a continuous release liner in a continuous carrier having tube clips mounted on one side of said release liner, said tube clips being spaced and parallel to each other on said release liner;
advancing said release liner from said continuous carrier around a direction reversal roller, said direction reversal roller being in contact with a side of said release liner opposite to the side containing said tube clips;
lifting each tube clip reaching said direction reversal roller from said release liner and transferring the lifted tube clip to a backing sheet.

8. The method of claim 7 in which said lifting means comprises a vacuum block for lifting each tube clip from said release liner, said vacuum block transporting the lifted tube clip to a point above the backing sheet located on a platform, and said vacuum block pushing said lifted tube clip against said backing sheet for attaching the lifted tube clip to said backing sheet, said vacuum block releasing said tube clip.

9. The method of claim 8 in which said advancing means also comprises a driven roller in contact with an idler roller, said driven roller pulling said release liner from said continuous carrier around said direction reversal roller a distance equal to the spacing of said tube clips on said release liner between each removal of a tube clip from said release liner so that the next tube clip is in a position to be engaged by said vacuum block.

10. The method of claim 7 wherein said continuous carrier is a roll.

11. The method of claim 7 wherein said continuous carrier is a stacked array of discrete fan fold sheets.

12. The method of claim 7 wherein said tube clips are mounted upon said release liner spaced adjacent to each other and a temporary holding block temporarily holds each subsequent tube clip of said tube clips while a preceding advanced tube clip is being pulled from said release liner by said vacuum block.

13. The method of claim 7 wherein said tube clips are mounted upon said release liner in a spaced apart relationship with a gap therebetween and an advanced tube clip of said tube clips is being pulled from said release liner by said vacuum block.

14. The method of sequentially mounting document holding tube clips on backing sheets comprising the steps of:
loading a continuous carrier of document holding tube clips on a holder, said continuous carrier comprising a continuous release liner having tube clips mounted on one side of said release liner, said tube clips being spaced and parallel to each other on said release liner;
placing a stack of backing sheets in position to receive said tube clips;
actuating a mechanism to advance said release liner from said continuous carrier around a direction reversal roller until a tube clip on said release liner is adjacent said direction reversal roller, said direction reversal roller being in contact with a side of said release liner opposite to the side containing said tube clips;
lowering a vacuum block to the tube clip adjacent said direction reversal roller;
applying vacuum to said vacuum block to engage said tube clip;
raising said vacuum block to lift said tube clip from said release liner;
moving said vacuum block holding said tube clip to an attach position above said stack of backing sheets;
lowering said vacuum block to and pressing said tube clip against a backing sheet on said stack of backing sheets until said tube clip adheres to backing sheet;
shutting off vacuum to said vacuum block to release said tube clip adhered to said backing sheet;
advancing said continuous carrier of release liner until the next tube clip is adjacent said direction reversal roller; and
returning said vacuum block to its position above the next tube clip and repeat the cycle.

15. The method as in claim 14 wherein said continuous carrier is a roll.

16. The method as in claim 14 wherein said continuous carrier is a stacked array of discrete fan fold sheets.
